(19) United States
(12) Patent Application Publication
(10) Pub. No.: US 2005/0071672 A1
(43) Pub. Date: Mar. 31, 2005

(54) [BRIDGE PROTOCOL DATA UNIT (BPDU) AUTHENTICATION MECHANISMUSING BRIDGE ADDRESS PERMIT LIST (BAPL)]

(76) Inventor: Hei-Tao Fung, Taipei (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 10/605,398

(22) Filed: Sep. 29, 2003

(51) Int. Cl. H04L 9/00; H04L 12/28

(52) U.S. Cl. 713/201; 370/256

(57) ABSTRACT

In a network, the spanning tree protocol computes a loop-free and fully connected active bridged network topology. A Bridge Address Permit List (BAPL) can be a simple Bridge Protocol Data Unit (BPDU) authentication mechanism to prevent the active bridge network topology from being disturbed by mis-configurations or illegal BPDUs perhaps from ill intentions. A BAPL is a simple but effective BPDU authentication method, using permit list to filter unauthorized BPDUs.

### BACKGROUND OF INVENTION

1. Field of the Invention

The present invention relates to a mechanism that filters out unauthorized Bridge Protocol Data Units (BPDUs). More particularly, the present invention relates to a mechanism that filters out unauthorized BPDUs using a Bridge Address Permit List (BAPL) as the filtering criteria for achieving security.

2. Description of Related Art

The Spanning Tree Protocol (STP) computes a loop-free and fully connected active bridged network topology. It recomputes the active topology, adapting to changes in the network such as a switch becoming active or inactive and a link becoming active or inactive. Such an adaptive capability works, but the network can suffer from unintended active topology change due to mis-configurations or ill intentions. For example, the STP bridge priority is increased, i.e. lowered in value, on a switch never intended to be a root bridge, causing the traffic crossing a narrower bottleneck from one leaf switch to another. Referring to FIG. 1, switch A and switch B can be chosen as the potential root bridges because they have higher bandwidth. When switch A is the root bridge, normally switch C has the port connected to switch B in blocking state. Traffic between switch A and switch B are straight through. Now if switch C is mis-configured to be the root bridge, traffic between switch A and switch B will go through switch C that has a lower bandwidth.

Should there be an authentication method on the bridge protocol data units (BPDUs), the unintended BPDUs can be ignored and will not cause topology change. However, there is little provision for BPDU authentication in IEEE Standards 802.1D or 802.1w.

Therefore, a BAPL can be a simple but quite effective BPDU authentication method for resolving the issues in the present invention.

### SUMMARY OF INVENTION

One object of this present invention is to provide a mechanism using Bridge Address Protocol List that filters out unauthorized Bridge Permit Data Units, for preventing a the active bridge network topology from being disturbed by mis-configurations or illegal BPDUs.

Inside a BPDU, there is a root identifier field and a bridge identifier field. The root identifier uniquely identifies the bridge assumed to be the root by the bridge sending a configuration BPDU (IEEE Standards Section 8.5.1.1 in 802.1D). The bridge identifier uniquely identifies the sender of another configuration BPDU (IEEE Standards Section 8.5.3.7 in 802.1D). Both identifiers have identical format because the root identifier is one of the bridge identifiers in the bridged network. The format of a bridge identifier is specified in IEEE Standards Section 9.2.5 802.1w. It has 64 bits consisted of three parts. The first part is a 4-bit bridge priority, the second part is a 12-bit locally assigned system identifier, and the third part is a 48-bit bridge address. The bridge address (defined in IEEE Standards Section 7.12.5 in 802.1D) is a globally unique Media Access Control (MAC) address assigned to the bridge. The bridge address may be the individual MAC address of a port.

On the other hand, the authentication process is embodied as follows. A switch can authenticate a received configuration BPDU by looking at the bridge addresses of the bridge identifier and the root identifier. The rules can be stated as follows: 1. If the received BPDU uses the bridge address of the switch, the BPDU is permitted. The switch bridge address is always in the permit list implicitly. 2. A received BPDU is ignored if the bridge address of its bridge identifier field does not match any bridge address in the permit list. 3. A received BPDU is ignored if the bridge address of its root identifier does not match any bridge address specified as also for root identifier checking in the permit list. 4. When a BPDU is ignored due to the application of the above rules, the receiving port's Spanning Tree Protocol (STP) state machine is “reset” as if the port has just become operational. Statistics can be updated, and end-users can be warned. It is so that the port will be in discarding state, preventing a loop, and the “correct” BPDUs are still transmitted. In the case that the port is an edge port, its operEdge variable should be set false so that the port will not transit to forwarding state immediately. When there is no more violating BPDU received, the port will transit to forwarding state later. Even if the port is an edge port, the port should stay in discarding state for waiting for a forwarding delay.

Those rules are applicable only when the spanning tree algorithm is enabled on the switch, yet those rules are applicable even when STP is disabled on a port or when the port is out of STP's control. That is, as long as the STP mechanism can receive the BPDUs and is aware of the receiving port, but the port's STP state machine will not be affected, only that the violating BPDUs are dropped, statistics are updated, and end-users are warned. Notice that those rules are compatible with the spanning tree algorithm.

The permit list is a set of bridge addresses allowed in received BPDUs. They can be configured on the switch. A configured bridge address can be specified as also applicable to root identifier checking.

The switch's bridge address is always part of the list so that it can permit BPDUs originated from itself, although BPDUs originated on the same port as the receiving port will be discarded.

The BAPL mechanism is compatible with STP. End-users can benefit from the feature in some ways, as well as specify the expected potential root bridges by specifying their bridge addresses in the permit list to trigger root identifier checking.

End-users can specify the bridge domain to be trusted by specifying a permit list. When a distrusted switch tries to join the bridge domain, it will fail.

The BAPL mechanism can be considered as a simple-minded authentication mechanism. The reason is that an ill-intentioned device can forge a BPDU with a permitted bridge address and try to disturb the topology of the trusted domain.

Considering deployment of the present invention, the feature can be deployed on switches in the distribution layer as well as the access layer. When deployed on a distribution switch, most, if not all, bridge addresses can be considered as trusted. Only potential root bridges are to be limited, and the features on one to all distribution switches are configured therein. Further, when deployed on an access switch, the uplink ports can be considered as trusted. The permit list can allow the bridge addresses of the peer switches connected to the uplink ports. The potential root bridges are simply limited.

A special case is having a null permit list. Then the switch itself is expected to the root bridge.

These and other objects, features and advantages of the present invention will become apparent from the following detailed description of illustrative embodiments thereof, which is to be read in connection with the accompanying drawings. It is to be understood that both the foregoing general description and the following detailed description are exemplary, and are intended to provide further explanation of the invention as claimed.

### BRIEF DESCRIPTION OF DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a block diagram illustrating a wrong root bridge according to a conventional method.

FIG. 2 is a block diagram illustrating a permit list to guard against unexpected root bridge according to one preferred embodiment of this invention.

FIG. 3 is a block diagram illustrating a permit list to define trusted bridge domain according to one preferred embodiment of this invention.

FIG. 4 is a table depicting BAPL configuration commands according to one preferred embodiment of this invention.

FIG. 5 is a table depicting BAPL execution commands according to one preferred embodiment of this invention.

### DETAILED DESCRIPTION

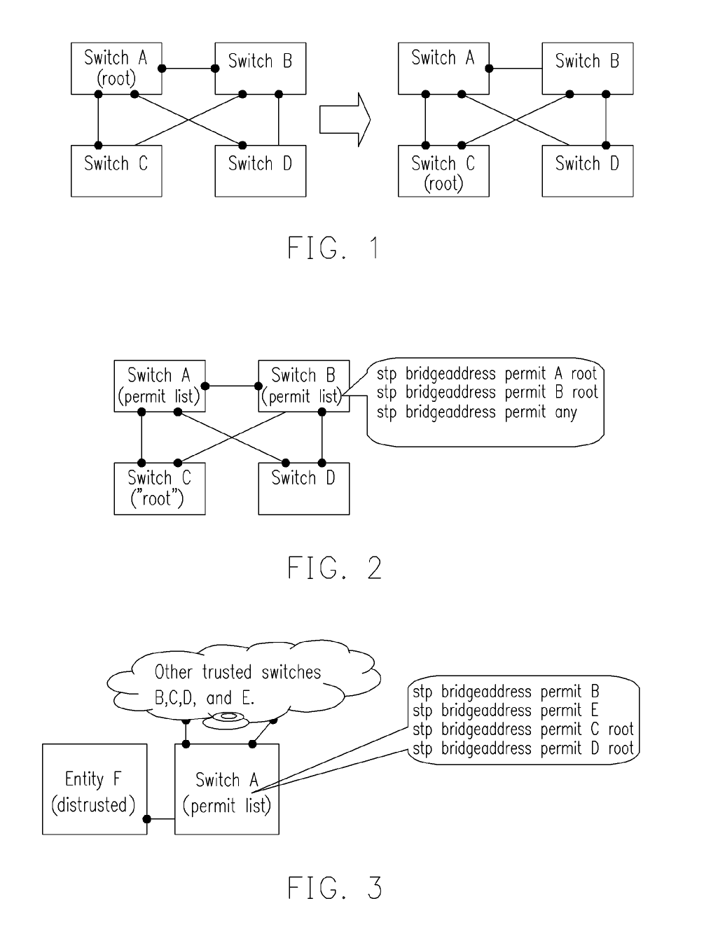

According to one preferred embodiment of this present invention, end-users can specify the expected potential root bridges by specifying their bridge addresses in the permit list to trigger root identifier checking. Referring to FIG. 2, by specifying on switch A and switch B a permit list that allows only switch A or switch B to be the root bridge, the violation can be detected while the topology is kept stable accordingly.

End-users can specify the bridge domain to be trusted by specifying a permit list. When a distrusted switch tries to join the bridge domain, it will fail. For example referring to FIG. 3 according to one preferred embodiment of this present invention, switches A, B, C, D, and E form a trusted domain. Switch C and switch D are the expected potential root bridges. Port 3 is connected a distrusted entity F, where entity F is supposed to s terminal or a “down-streamed” bridge. When entity F tries to send BPDUs, switch A will deny its connectivity. If entity F is meant to be a “down-streamed” bridge, it should stop sending BPDUs after receiving the superior BPDU from switch A, and the denial of connectivity is temporary.

According to one preferred embodiment of this present invention, one example of entity F is a traffic monitor while port 3 is a port copy destination port. Another example of entity F is a customer switch while the customer is leasing port 3 from the service provider owning switch A.

The BAPL can be considered as a simple-minded authentication mechanism. The reason is that an ill-intentioned device can forge a BPDU with a permitted bridge address and try to disturb the topology of the trusted domain. Referring to FIG. 3 as one preferred embodiment, entity F can sniff the BPDUs out from port 3 and find out the permitted root bridge identifier and bridge identifier. It then sends a BPDU, with the same root bridge identifier but with a higher bridge priority. The BPDU will go through the BAPL on switch A, fooling switch A to believe that the root bridge has moved to port 3. However, that trick does not always work. For example, the real root bridge has used the highest bridge priority possible. Then, entity F at best can generate a BPDU with the same bridge priority. Now the deciding factor is the root path cost. If switch A has a lower port path cost on port 1 and port 2 than on port 3, the active topology will remain unchanged. Therefore, it is advisable to configure the highest bridge priority in the root bridge, and perhaps also configure a huge port path cost on distrusted ports.

As depicted in FIG. 2 and FIG. 3, the feature can be deployed on switches in the distribution layer as well as the access layer.

When deployed on a distribution switch, most, if not all, bridge addresses can be considered as trusted. Only the potential root bridges are limited, and the one to all distribution switches are featured on.

When deployed on an access switch, the uplink ports can be considered as trusted. The permit list can allow the bridge addresses of the peer switches connected to the uplink ports. Only the potential root bridges are limited.

A special case is having a null permit list. Then the switch itself is expected to the root bridge.

The extra CPU load is minimal. Some memory is consumed to storing configuration and run-time data. Developers may limit the amount of buffer to store the violating bridge address, for example to the last 100 of them.

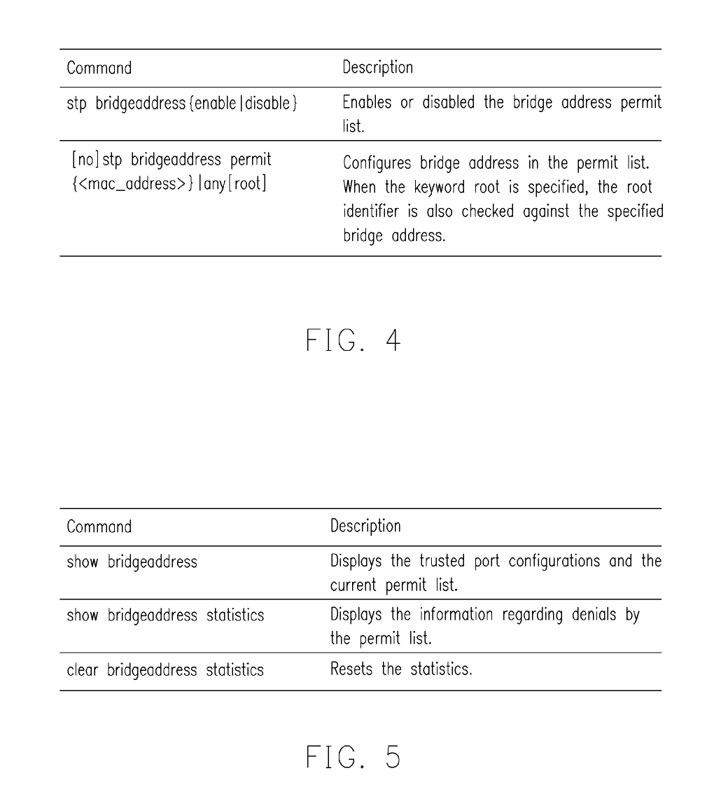

Referring to the table depicted in FIG. 4, a command field and a description field are depicted herein. By default the BAPL mechanism is disabled. When it is disabled, the BAPL mechanism is stopped, but configurations and run-time data are not affected. When it is enabled, then the mechanism is effective when Spanning Tree Protocol (STP) is also enabled. By default, the permit list is empty (except an implicit bridge address of the local switch), so all BPDUs originated from other switches are denied. It is advised to disable the mechanism first before modifying the permit list. After the permit list has been fully configured, enable the mechanism.

Referring to FIG. 5, wherein a command field and a description field are depicted herein. The “show bridgeaddress” command displays the configurations of the permit list. It also reports the switch's own bridge address, which is implicitly in its permit list always. It may also report some of bridge addresses seen on the switch (such as those of the neighboring designated bridges). That can help end-users find out the bridge addresses when they try to configure the permit list. The “show bridgeaddress statistics” command reports the number of BPDUs discarded by the permit list on each violating port and some of the violating bridge addresses.

It will be apparent to those skilled in the art that various modifications and variations can be made to the structure of the present invention without departing from the scope or spirit of the invention. In view of the foregoing, it is intended that the present invention covers modifications and variations of this invention provided they fall within the scope of the following claims and their equivalents.

1. An authentication mechanism, for a network where a spanning tree protocol is performed comprising a plurality of bridges, a plurality of layers, a plurality of switches, and a plurality of ports, the authentication mechanism comprising:
a plurality of bridge protocol data units;
a permit list; and
a plurality of authentication rules.

2. The authentication mechanism as recited in claim 1, wherein the bridge protocol data unit comprises:
a root identifier field; and
a bridge identifier field.

3. The authentication mechanism as recited in claim 1, wherein the permit list comprises a plurality of bridge addresses allowed in the bridge protocol data units that are received.

4. The authentication mechanism as recited in claim 1, wherein the authentication rules comprise:
if the bridge protocol data unit that is received uses the bridge address of the switch, the bridge protocol data unit is permitted;
if the bridge address of the bridge identifier does not match the bridge addresses in the permit list, the bridge protocol data unit that is received is ignored; and
if the bridge address of the root identifier does not match the bridge addresses in the permit list, the bridge protocol data unit that is received is ignored.

5. The authentication mechanism as recited in claim 1, wherein the port further comprises a state machine.

6. The authentication mechanism as recited in claim 4, wherein when the port receiving the bridge protocol data unit that fails the bridge address permit list, the authentication rules further comprises:
the state machine of the spanning tree protocol port being reset;
the bridge protocol data units that pass the permit list being processed;
an operEdge variable being set to false if the port is an edge port; and
resuming when none of the bridge point data units failing the permit list have been received for a period.

7. The authentication mechanism as recited in claim 6, wherein the period is in the order of tens of seconds.

8. The authentication mechanism as recited in claim 6, wherein the authentication rules are applicable when the spanning tree protocol is enabled on the switch.

9. The authentication mechanism as recited in claim 1, wherein the bridge address of the bridge potentially being a root bridge is specified in the permit list, for triggering a root identifier checking.

10. The authentication mechanism as recited in claim 1, wherein all the switches in a bridge domain that is trusted are specified in the permit list.
